(19) United States
(12) Patent Application Publication
(10) Pub. No.: US 2009/0151506 A1
(43) Pub. Date: Jun. 18, 2009

(54) Method For Producing A Steering Wheel, And Steering Wheel Produced By Means Of The Method

(76) Inventors: Christian Haart, Obernburg (DE); Jürgen Kolb, Aschaffenburg (DE); Daniel Henning, Aschaffenburg (DE)

Correspondence Address: FITCH EVEN TABIN AND FLANNERY, 120 SOUTH LASALLE STREET, SUITE 1600, CHICAGO, IL, 60603-3406, US

(21) Appl. No.: 12/280,890

(22) PCT Filed: Feb. 26, 2007
(86) PCT No.: PCT/EP2007/001739

§ 371 Date: Dec. 29, 2008

(30) Foreign Application Priority Data
Feb. 27, 2006 (DE) 10 2006 010 155.3

(51) Int. Cl. B62D 1/06

(52) U.S. Cl. 74/558; 29/894.1

(57) ABSTRACT

The invention relates to a method for producing a steering wheel, having the following steps: arranging and fastening at least one steering wheel covering element to the steering wheel skeleton after an outer layer of the steering wheel has been connected to the outside of the at least one steering wheel covering element. The invention also relates to a steering wheel, produced by means of the method, for a motor vehicle, in which it is provided according to the invention that the at least one steering wheel covering element is designed and provided to be arranged on and fastened to the steering wheel skeleton after the outer layer has been connected to the outside of the at least one steering wheel covering element.

The present invention relates to a method for producing a steering wheel and a steering wheel produced by means of the method, according to the preamble of claim 26.

Such steering wheels are supported on a motor vehicle so that they can rotate about a steering axis and as essential elements comprise a steering wheel rim, which revolves around the steering axis in a circumferential direction and serves for operation of the steering wheel, together with spokes for joining the steering wheel rim to a hub of the steering wheel, via which the steering wheel can be supported on the motor vehicle. Emerging from the hub, the individual spokes of the steering wheel open out into the steering wheel rim transversely to the circumferential direction of the steering wheel rim.

Known steering wheels have a steering wheel skeleton comprising a steering wheel rim skeleton as a body of the steering wheel rim and struts protruding from the steering wheel rim skeleton as bodies of the spokes of the steering wheel. Fixed to the steering wheel skeleton is at least one steering wheel covering element, with an inside facing the steering wheel skeleton and an outside remote from the inside, which serves as a carrier for an outer, visible layer of the steering wheel (such as a leather cover, for example) which is joined to the outside of the steering wheel covering element.

In known production methods the steering wheel covering element is molded directly onto the steering wheel skeleton. The outer, visible layer of the steering wheel is then produced separately and fixed to the steering wheel covering element firmly joined to the steering wheel skeleton. For this purpose, for example, individual punched leather parts of an outer layer of the steering wheel are stitched together to form a closed ring of leather strips, which is drawn over the foam-enclosed steering wheel rim skeleton and positioned thereon. The ring of leather strips and the steering wheel molding (steering wheel rim skeleton with molded-on steering wheel covering element) are bonded with an adhesive. The leather is then stitched at the joints. In addition, the leather may be subjected (where wrinkling occurs, for example) to some form of heat treatment, so that the ring of leather strips shrinks due to the resulting abstraction of moisture. Such treatment may also be confined to individual areas of the steering wheel.

Disadvantages of the aforementioned method are the material wastage occasioned by the separate production of the entire outer layer and the higher material costs associated with this. Defects in the leather can moreover often be detected only on completion of the leather facing. Different expansion characteristics may also mean that a complete leather covering has to be replaced in its entirety.

The object of the invention is to provide a method for producing a steering wheel and a steering wheel produced according to this method, ensuring an easy and cost-effective facing of the steering wheel.

This object is achieved by a method for producing a steering wheel having the features of claim 1, and by a steering wheel having the features of the co-ordinated claim 26.

The method according to the invention provides for the following steps:
provision of a steering wheel skeleton as a body of the steering wheel to be produced,
provision of one or more steering wheel covering elements to be fixed to the steering wheel skeleton as carriers for an outer, visible layer of the steering wheel, all of the steering wheel covering elements together, in the state in which they are affixed to the steering wheel skeleton, in essence completely enclosing at least a partial area of the cross section of the steering wheel skeleton and the steering wheel covering elements each having an inside facing the steering wheel skeleton and an outside remote from the inside,
joining an outer layer to the outside of at least one steering wheel covering element, the outer layer, in the state in which at least one steering wheel covering element is affixed to the steering wheel skeleton, in essence completely enclosing at least a partial area of the cross section of the steering wheel skeleton, and
arrangement and fixing of at least one steering wheel covering element on the steering wheel skeleton once the outer layer has been joined to the outside of at least one steering wheel covering element.

An essentially complete enclosure of the steering wheel skeleton (that is to say the cross section of the steering wheel skeleton) by the steering wheel covering elements and the outer layer is taken to mean a 360° enclosure of the steering wheel skeleton, the steering wheel covering elements and the outer layer naturally enclosing the steering wheel skeleton except for the gaps, which are formed by adjacent end faces of steering wheel covering elements or by adjacent end faces of constituent parts of the outer layer of the steering wheel, for example adjacent individual layer elements, from which the outer layer is constructed. A cross section of the steering wheel skeleton is furthermore taken to mean a cross section of the steering wheel rim skeleton or a strut of the steering wheel skeleton, the cross sectional plane in each case being oriented perpendicular to the circumferential direction of the steering wheel rim skeleton or perpendicular to a direction in which the strut extends longitudinally.

The aforementioned steps in the method according to the invention make it possible to fit the outer layer more reliably and more cost effectively in each of the predefined positions of the steering wheel. In contrast to the known method, this dispenses with the complex operation of assembling the outer layer before this is joined to the steering wheel covering.

The outer layer is preferably formed in such a way that after joining to the outside it covers the outside of at least one steering wheel covering element. That is to say a flexible outer layer, such as leather, for example, is cut to size so that it is congruent with the outside of the steering wheel covering element, it being possible to provide an excess, so that an outer edge of such an outer layer can be turned in.

One or more of the steering wheel covering elements is/are preferably fixed to the steering wheel skeleton in such a way that all of the steering wheel covering elements together in essence completely enclose the steering wheel skeleton. That is to say all of the steering wheel covering elements together enclose the steering wheel skeleton and the struts completely, except for gaps which are formed by adjacent end faces of those covering elements. Here the hub of the steering wheel can also be faced by means of one or more steering wheel covering elements, forming a hub body of the steering wheel.

It is especially preferred if the outer layer is formed from a flexible material, in particular from a leather. The method according to the invention is also suited, however, to the processing of other outer layer materials, including wood and stone.

The outer layer preferably has an inside, which for joining to the outside of at least one steering wheel covering element is deformed in such a way that it conforms to a three dimensional profile of the outside of the steering wheel covering element. In the case of a leather, for example, such a deformation can be produced by a heat treatment of the leather whilst simultaneously fixing the leather in the desired shape.

For joining the outer layer to at least one steering wheel covering element, said layer is preferably joined to the outside of at least one steering wheel covering element by a materially fused connection, for example by means of an adhesive. Said element is preferably joined by its inside positively interlocking with the steering wheel skeleton. In a further variant of the invention at least one steering wheel covering element is joined by its inside materially fusing with the steering wheel skeleton. Alternatively, the inside is used to produce a frictional connection between at least one steering wheel covering element and the steering wheel skeleton.

Multiple steering wheel covering elements are preferably provided, which are each assigned to different areas of the steering wheel skeleton. Similarly, in one variant of the method according to the invention the outer layer is also formed from multiple layer elements. At least one of the layer elements is preferably assigned to each of the individual steering wheel covering elements.

The layer elements are furthermore preferably formed in such a way that, after joining the layer elements to the outsides of the steering wheel covering elements, they cover the outsides of the steering wheel covering elements.

In a variant of the method according to the invention, at least one insert is preferably provided, which after fixing one or more steering wheel covering elements to the steering wheel skeleton, serves for arrangement in a gap, which is formed by opposing sides of one or more layer elements fixed to at least one steering wheel covering element. Such inserts can furthermore be designed as decorative trim elements. It is possible, for example, for the steering wheel covering elements to be fixed to the steering wheel skeleton or the layer elements to be fixed to the steering wheel covering elements in such a way that a gap of the aforesaid type extends in a circumferential direction along the steering wheel rim, for example, so that a circumferential decorative trim ring of wood, for example, can be arranged in the gap. Such inserts are furthermore preferably designed to interlock positively in the gap to be filled and are preferably fixed in the gap by means of an adhesive. Other means of fixing, such as catches, are naturally also feasible in this context.

In an especially preferred variant of the invention the cross sectional contour of the steering wheel skeleton is formed, though the foam expansion of a shell of the steering wheel, for example, in such a way that it differs in shape from a circular cross sectional contour, in order to prevent any cross sectional contour, in order to prevent any twisting of the steering wheel covering elements to be fixed to the steering wheel skeleton and the steering wheel rim skeleton transversely to the circumferential direction of the steering wheel rim. Here the cross sectional contour is preferably of polygonal, especially rectangular shape, in which the corners of such a polygonal cross sectional contour may perfectly well be rounded.

In a variant of the method the step of providing a steering wheel skeleton may comprise the following steps:
provision of a core for the steering wheel skeleton, especially one composed of metal, and
enclosure of the core in a casing, especially one composed of a foam (such as PU foam, for example) in order to form the actual steering wheel skeleton, so that the casing, at least in sections, completely encloses the cross section of the core. The casing preferably completely encloses a part of the core assigned to the steering wheel rim (except for points at which spokes open out into the steering wheel rim).

In one variant of the method, projections protruding from the steering wheel skeleton are provided thereon as anchorages, which are designed to engage in corresponding recesses in the inside of at least one steering wheel covering element, so that changes in the length of the steering wheel covering elements due to climatic influences (heating and cooling) are prevented. Here the projections are preferably provided on that part of the steering wheel skeleton which forms a body for the steering wheel rim of the steering wheel, that is to say on the steering wheel rim skeleton.

It is especially preferred if those projections acting as anchorages are integrally formed with the casing, for example through foam expansion or injection molding of the casing in a corresponding mold.

Alternatively or in addition to the anchorages in the form of projections, a rough and/or grained surface texture is formed on an outward facing exterior (surface) of the steering wheel skeleton, in particular the casing. Compared to the roughness formed by a fine texturing of the surface, the graining is coarser, thereby providing a coarse texturing of said outside. The inside of the steering wheel covering elements may be similarly formed.

The roughness and/or graining provided on the outside of the casing and/or the inside of the steering wheel covering elements affords greater friction between the steering wheel skeleton (casing) on the one hand and the steering wheel covering elements on the other, likewise serving to counteract any climatically induced variation in the positions of the steering wheel covering elements fixed to the steering wheel skeleton.

The object of the invention is also achieved by a steering wheel having the features of claim 26.

In the case of such a steering wheel for a motor vehicle, having a steering wheel skeleton as a steering wheel body, with one or more steering wheel covering elements fixed to the steering wheel skeleton as carriers for an outer, visible layer of the steering wheel, all of which elements together in essence completely enclose at least a partial area of the cross section of the steering wheel skeleton and which each have an inside facing the steering wheel skeleton and an outside remote from the inside, and having an outer layer which is joined to the outside of at least one steering wheel covering element, the outer layer in essence completely enclosing at least a partial area of the cross section of the steering wheel skeleton, at least one steering wheel covering element is according to the invention designed to be arranged and fixed on the steering wheel skeleton, once the outer layer has been joined to the outside of at least one steering wheel covering element.

The outer layer preferably covers the outside of at least one steering wheel covering element in its entirely. In a further variant of the invention, all of the steering wheel covering elements together completely enclose the steering wheel skeleton, that is to say they form an all-round covering for the steering wheel skeleton. At the same time a hub of the steering wheel may also be enveloped by the steering wheel covering element(s).

It is especially preferred if the outer layer is produced from a flexible material, in particular from a leather or a material of comparable characteristics.

According to one embodiment of the invention, the outer layer is joined to the outside of at least one steering wheel covering element by a materially fused connection. The inside of at least one steering wheel covering element furthermore preferably bears on the inside of the steering wheel skeleton, positively interlocking therewith. The positive interlock advantageously allows an extensive bonded connection between at least one steering wheel covering element and the steering wheel skeleton. The steering wheel covering elements can naturally also be fixed to the steering wheel skeleton by means of (known) alternative fixing methods, for example by catches or by welding.

In a variant of the invention at least one steering wheel covering element in cross section has two opposing legs integrally joined to one another, which can be bent apart to bracket or to enclose the steering wheel skeleton. The legs here each have a free end, the free ends, in a state in which the steering wheel covering element encloses the steering wheel skeleton, bearing against one another so that the steering wheel covering element preferably enclose the cross section of the steering wheel skeleton over 360°. In this case, sections which in cross section are not fully enclosed by a steering wheel covering element may be provided along the steering wheel rim skeleton or along the struts. Such areas may be areas, for example, in which the struts of the steering wheel skeleton open out into the steering wheel rim skeleton.

In one exemplary embodiment of the invention, multiple steering wheel covering elements are provided, a first steering wheel covering element preferably extending over half of the circumference of a closed steering wheel rim skeleton of the steering wheel skeleton. Half of the circumference preferably means the right-hand or left-hand side of the steering wheel rim skeleton, relative to the straight-ahead driving position of the steering wheel in the fitted state of the steering wheel in the motor vehicle. Here the right-hand and left-hand sides of the steering wheel rim skeleton are preferably defined by the plane of symmetry of the steering wheel skeleton, which with a steering wheel in the straight-ahead driving position is spanned by the steering axis and a vehicle axis intersecting the steering axis and running parallel to the vertical axis of the vehicle.

The first steering wheel covering element in essence preferably fully embraces the cross section of the steering wheel rim skeleton, areas possibly being provided along the steering wheel rim skeleton, such as points at which the struts merge into the steering wheel rim skeleton, which in cross section are not fully enclosed.

A second steering wheel covering element is furthermore preferably provided, which extends along at least one strut of the steering wheel skeleton that serves to join the steering wheel rim skeleton to a hub of the steering wheel, the second steering wheel covering element embracing the struts at least in sections (preferably over an entire length of the strut extending between the hub and the steering wheel rim skeleton.

In a further variant of the invention the second steering wheel covering element extends along the first strut and along a further, second strut, which likewise serves to join the steering wheel rim skeleton to the hub of the steering wheel, the second steering wheel covering element additionally covering an area of the steering wheel rim skeleton which extends in the circumferential direction of the steering wheel rim skeleton and joins the two struts together. At the same time the second steering wheel covering element preferably embraces the cross section of the two struts over 360°.

A third and a fourth steering wheel covering element are furthermore provided, which are mirror symmetrical (about the plane of symmetry of the steering wheel) with the first and second steering wheel covering elements respectively, and are fixed to the steering wheel skeleton.

In one exemplary embodiment of the invention one (or more) of the steering wheel covering elements is/are fixed to the steering wheel skeleton by means of at least one catch fixed to the inside of the steering wheel covering element. Such steering wheel covering elements may be those steering wheel covering elements, for example, which cover areas of the steering wheel rim skeleton that extend on the steering wheel rim skeleton between the struts and which face the hub of the steering wheel.

At least one catch preferably engages in a recess in the steering wheel skeleton in order to join one steering wheel covering element to the steering wheel skeleton.

In a variant of the invention the steering wheel skeleton is advantageously of U-shaped cross section, the recess for fixing the one steering wheel covering element being formed on the U-shaped steering wheel skeleton in such a way that a free leg of the U-shaped steering wheel skeleton is situated opposite the recess in an assembly direction aligning with the recess.

It is furthermore advantageous for the outer layer to be formed from a plurality of layer elements, at least one layer element in each case being joined to the outside of a steering wheel covering element, preferably in such a way that it completely covers the outside of the steering wheel covering element.

It is also possible for the steering wheel covering elements and also the outer layer of the steering wheel to likewise embrace or completely cover the cross section of the hub of the steering wheel. Here the steering wheel covering elements may, in particular, also form a hub body, which may serve, for example, as accommodation for an airbag or other functional elements of a motor vehicle.

All of the steering wheel covering elements may be arranged on the steering wheel skeleton in such a way that gaps (or interstices), which are preferably closed by inserts, running along the steering wheel rim or along the spokes are formed between adjacent sides of the steering wheel covering elements and/or between adjacent layer elements of the outer layer of the steering wheel. Such inserts may be formed, in particular, as decorative trim elements of wood, stone or leather, decorative trim elements of leather, when arranged in a gap, preferably having a visible seam, for example a stitched seam, as decorative element.

The steering wheel covering elements are preferably produced from a plastic, especially a thermoplastic, or alternatively or in addition from a foam, in particular a PU foam.

In a variant of the invention the steering wheel skeleton provided has a cross sectional contour which, at least at one point, deviates from a circular cross sectional contour, so that a steering wheel covering element positively interlocking around the steering wheel skeleton cannot be twisted in relation to the steering wheel skeleton, that is to say the steering wheel rim skeleton, transversely to the circumferential direction of the steering wheel rim.

The steering wheel skeleton preferably has a heterogeneous structure, preferably having a core (K), which may be produced from a metal or a plastic (or possibly composite material) of comparable characteristics. The core is preferably enclosed by a casing, which in cross section preferably encloses the core completely, especially where this forms a framework for the steering wheel rim skeleton, the exception being areas of the core into which struts emanating from a hub body open out.

The steering wheel rim skeleton preferably has projections protruding from the steering wheel rim skeleton, which are designed and intended to engage in corresponding recesses in the inside of a steering wheel covering element. Here two projections preferably engage at an interval from one another in the circumferential direction of the steering wheel rim in two different, mutually spaced recesses in a steering wheel covering element, with the effect that changes in the length of the steering wheel covering element in question are prevented in the area between the recesses. In order to enhance this effect, the casing of the steering wheel skeleton is preferably composed of a material, the volume of which exhibits a significantly reduced increase or decrease in response to temperature fluctuations than the volumes of the individual steering wheel covering elements.

The projections (A) are preferably designed and intended to engage non-positively and/or by positive interlock in the associated recesses. The projections may be designed to grip behind areas of the respective recess with a view to a non-positive, frictional engagement.

It is especially preferred if the projections run around the cross section of the steering wheel rim skeleton (in the form of beads), the associated recesses being formed as grooves on the insides of the steering wheel covering elements.

In order to increase the friction between an outside of the steering wheel skeleton (casing), this preferably has a fine rough texture, or alternatively or in addition a grained texture. The inside of the steering wheel covering elements may be similarly designed.

It is especially preferred if at least one steering wheel covering element completely encloses the cross section of the steering wheel skeleton, in particular the steering wheel rim skeleton in one piece. That is to say at least one steering wheel covering element in cross section runs 360° around the steering wheel rim skeleton, adjacent end faces of the steering wheel covering element bearing tightly against one another and/or being joined together by a seam. The seam may be a bonded or welded joint (hot deformation), for example.

Further details and advantages of the invention are illustrated in the following description of exemplary embodiments, with reference to the drawings, in which:

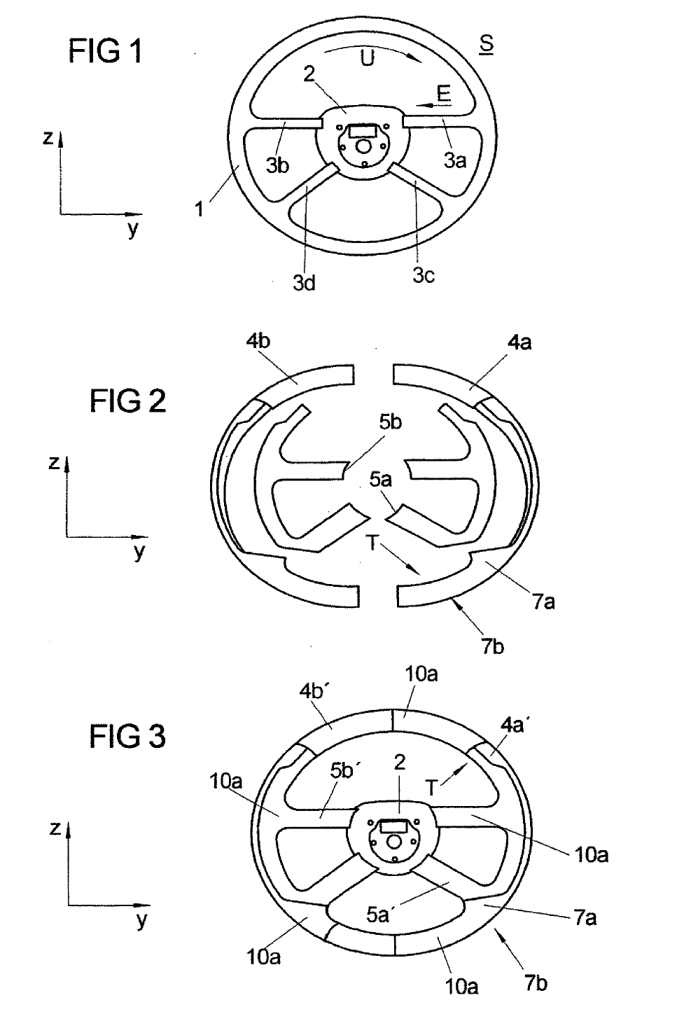

FIG. 1 shows a top view of a steering wheel skeleton, comprising a steering wheel rim skeleton and struts, which serve to join the steering wheel rim skeleton to a hub,

FIG. 2 shows a top view of four steering wheel covering elements,

FIG. 3 shows the steering wheel covering elements shown in FIG. 2, the outsides of which are in each case joined to a layer element and which are fixed to the steering wheel skeleton shown in FIG. 1,

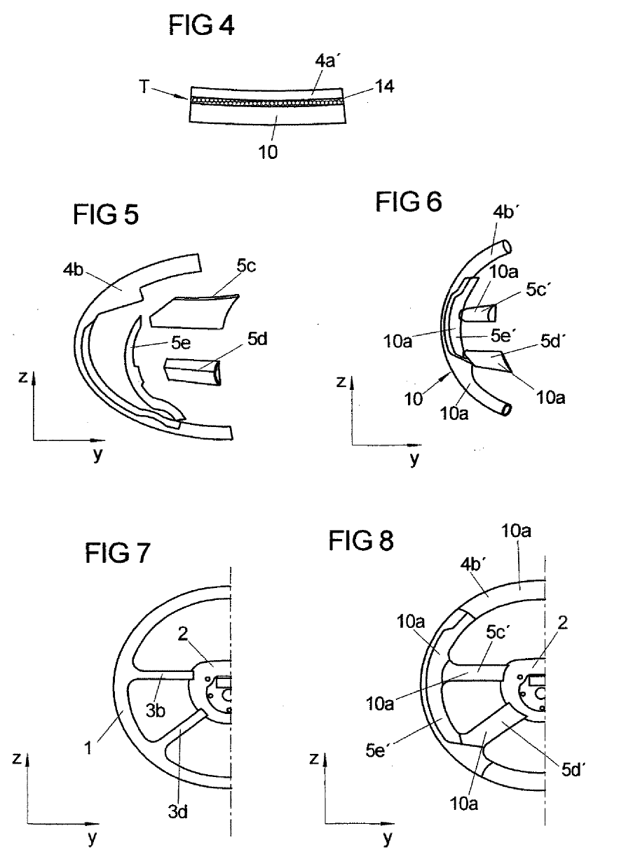

FIG. 4 shows a section of an outer layer of the steering wheel in the form of a leather element, which has a stitched seam,

FIGS. 5-10 show a schematic representation of the sequence in a method according to the invention for producing a steering wheel,

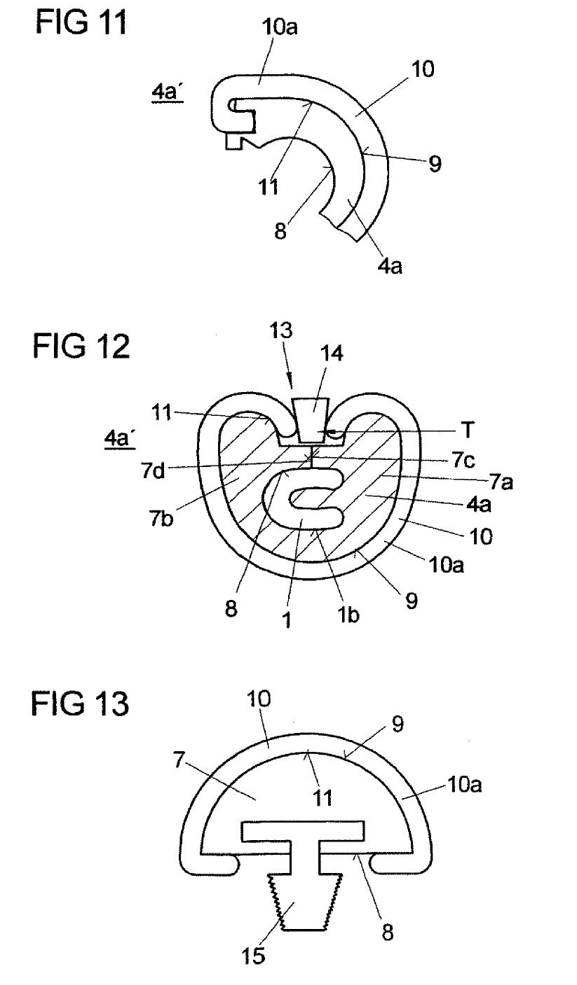

FIG. 11 shows a schematic, detailed sectional view of a steering wheel covering element and a layer element affixed thereto,

FIG. 12 shows a schematic sectional view of a modification of the steering wheel covering element shown in FIG. 11, as fixed to a steering wheel skeleton,

FIG. 13 shows a further modification of the steering wheel covering element shown in FIGS. 11 and 12,

FIG. 14 shows a schematic sectional view of a steering wheel skeleton of the type shown in FIG. 12, having a recess to receive a catch, and

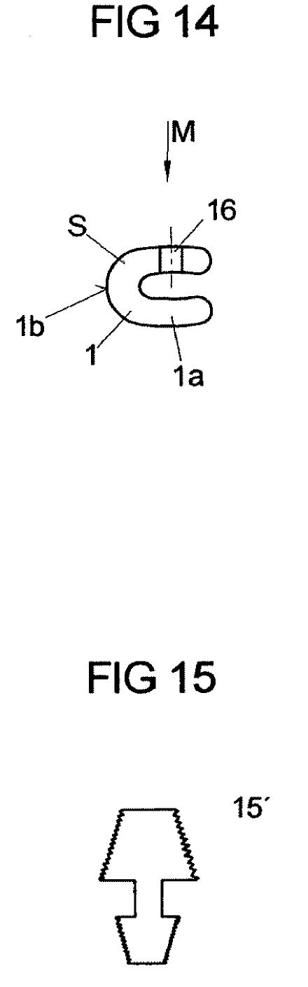

FIG. 15 shows a variant of the catch shown in FIG. 14,

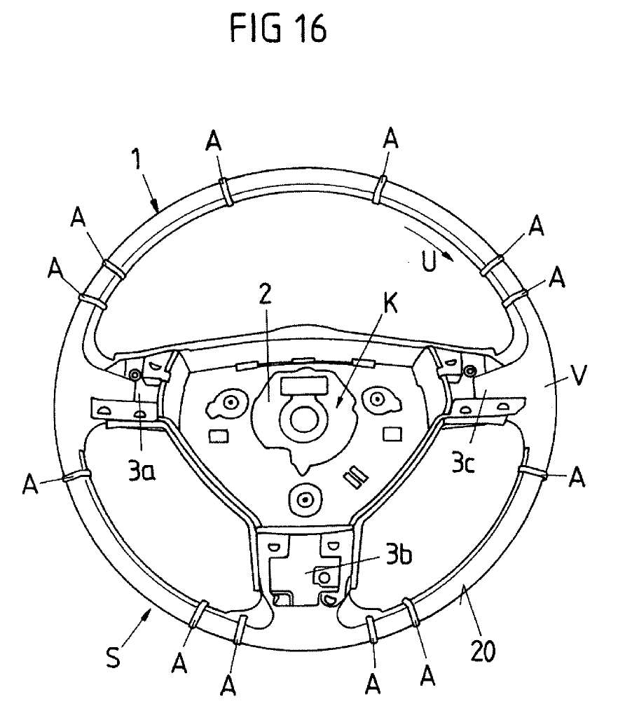

FIG. 16 shows a variant of a steering wheel skeleton, having a casing on which projections are provided in the form of annular beads,

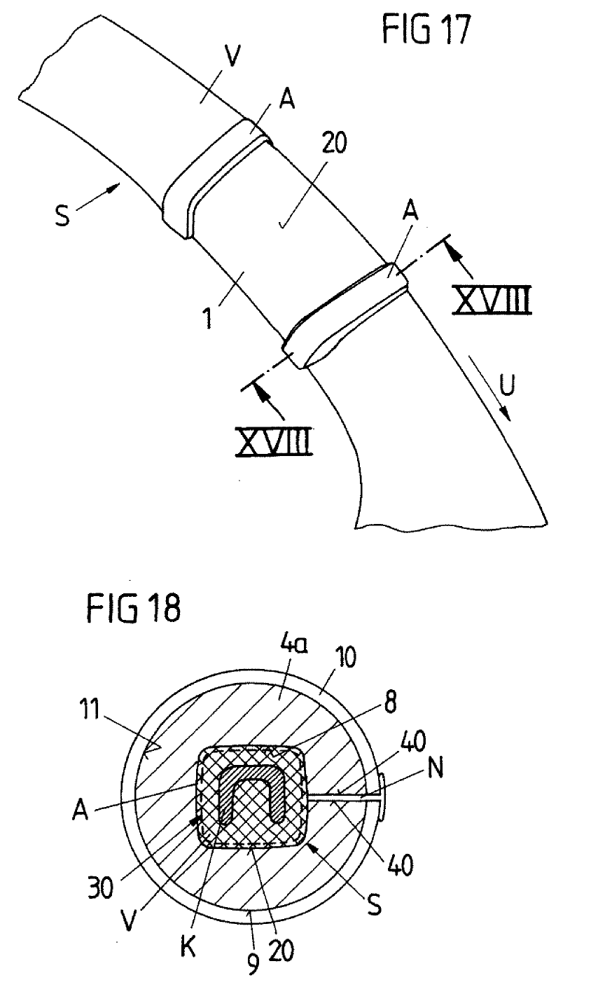

FIG. 17 shows a detail of the steering wheel rim shown in FIG. 16, and

FIG. 18 shows a section along the line XVIII-XVIII in FIG. 17, with the addition, compared to FIG. 17, of steering wheel covering elements enclosing the steering wheel skeleton.

FIG. 1 shows a top view of a steering wheel skeleton S, comprising a steering wheel rim skeleton 1, and four struts 3a, 3b, 3c and 3d, which join the steering wheel rim skeleton 1 to a hub 2. The steering wheel rim skeleton 1 runs in a circumferential direction U around a steering axis, which is perpendicular to the plane of projection and about which the steering wheel skeleton S is rotatably supported by way of the hub 2. The four struts 3a, 3b, 3c and 3d each extend in a direction E, in which they each in essence open out into the steering wheel rim skeleton 1 transversely to the circumferential direction U of the steering wheel rim skeleton 1.

In the following, three-dimensional specifications relating to the steering wheel and its constituent parts will relate to the steering wheel as fitted in a straight-ahead driving position in a motor vehicle, viewed as seen by a driver of the motor vehicle. Accordingly, a first strut 3a of the four struts 3a-3d extends on the right-hand side of the circular steering wheel rim skeleton 1 along the vehicle transverse axis y from the steering wheel rim skeleton 1 to the hub 2, and a further, second strut 3c extends, enclosing an acute angle with the first strut 3a, along the vertical vehicle axis z below the first strut 3a from the hub 2 to the steering wheel rim skeleton 1. The position of the third strut 3b and the fourth strut 3d ensues from a lateral inversion of the first strut 3a and the second strut 3c respectively in the plane of symmetry of the steering wheel skeleton S, which is spanned by the steering axis and a vehicle axis, running parallel to the vertical axis z of the vehicle and intersecting the steering axis.

FIG. 2 shows a top view of four separate steering wheel covering elements 4a, 4b, 5a and 5b, which are intended to be fixed to the steering wheel skeleton S shown in FIG. 1. Before they are positioned and fixed to steering wheel skeleton S, these elements are joined to an outer, visible layer 10 of the steering wheel, which may take the form of a leather, for example. The individual steering wheel elements 4a, 4b 5a and 5b may naturally also be faced with different layer elements 10a forming the outer layer 10, which are fixed adjacent one another, for example, on an outside of the steering wheel covering element intended for fixing of the outer layer 10. In this way it is possible, for example, to combine different materials such as wood, stone and leather with one another.

It is now proposed to explain the arrangement of the first and second steering wheel covering element 4a, 5a on the right-hand side of the steering wheel skeleton S, the arrangement on the left-hand side again ensuing from a lateral inversion of the of the right-hand side steering wheel skeleton S (and the parts affixed thereto) in its plane of symmetry. According to FIG. 3 (in association with FIG. 12), the steering wheel covering elements 4a, 4b, 5a and 5b, each covered with a layer element 10a in the form of an extensive leather element, enclose the steering wheel skeleton S in a state in which they are fixed to the steering wheel skeleton S (hereinafter referred to as the fixed state), the steering wheel rim skeleton 1 and the first and second struts 3a, 3c being enclosed transversely to the direction E in which they respectively extend by the first and second steering wheel covering elements 4a, 5a. Here a first steering wheel covering element 4a′ covered by a leather layer element 10 serves for facing the right-hand half of the steering wheel rim skeleton 1. For this purpose the first steering wheel covering element 4a′ is of hose-shaped design and curved so as to conform to the right-hand half of the steering wheel rim skeleton 1, that is to say the leather-faced first steering wheel covering element 4a′ has an inside 8, which is matched to the three-dimensional shape of a outward facing outside 1b of the steering wheel rim skeleton 1. In order that the leather-faced first steering wheel covering element 4a′ can be applied to the steering wheel rim skeleton 1, it has, in the direction of its longitudinal extent (which in the fixed state runs in the circumferential direction U of the steering wheel rim skeleton 1), an elongated opening in the form of a gap T, which can be bent open so that the first leather-covered steering wheel covering element 4a′ can be pushed onto the steering wheel rim skeleton 1. In the areas where the first and the second strut 3a, 3c open out into the steering wheel rim skeleton 1, the gap T is widened. The widened area of the gap T, together with the first and the second strut 3a, 3b, is covered by means of a further, second (leather-faced) steering wheel covering element 5a′.

A schematic cross section through steering wheel covering elements of this type, such as the first steering wheel covering element 4a′ provided with a layer element 10a in FIG. 3, for example, is represented in FIG. 12. According to this the first faced steering wheel covering element 4a′ has two legs 7a, 7b integrally formed with one another and extended in the longitudinal direction of the steering wheel covering element 4a′, each having a free end 7c, 7d, which border the gap T and are situated opposite one another when the steering wheel covering element 4a is in the fixed state, these preferably bearing against one another as in FIG. 12. The gap T may be widened by bending the two legs 7a, 7b apart transversely to its longitudinal direction, in such a way that the steering wheel covering element 4a can grip around and enclose the steering wheel rim skeleton 1. The steering wheel covering element 4a′ is therefore preferably composed of a flexible PU foam, or the two legs 7a, 7b are joined together via a flexible area. The necessary flexibility can likewise be set by way of a thickness of material in a connection between the two legs 7a, 7b of the steering wheel covering element 4a′.

The layer element 10a, which is applied on the outside 9 remote from the steering wheel rim skeleton 1 and is composed of leather, is driven into a recess in the steering wheel covering element 4a′, which serves to widen the gap T and is filled by an insert 14. The insert 14 may be composed of various materials and is preferably bonded into the widened part of the gap T, that is to say materially fused to the steering wheel covering element 4a′ and/or to the layer element 10a. FIG. 4 shows a top view of an insert 14 having a visible stitched seam.

FIG. 11 shows a modification of a steering wheel covering element of the type shown in FIG. 12, which in contrast to FIG. 12 is formed from a rigid plastic. In order that such carriers of an outer layer 10 of the steering wheel can be fixed to the steering wheel skeleton S, enclosing the latter, two steering wheel covering elements 4a, for example two half-shell shaped elements, may have to be provided, which are each capable of accommodating approximately one half of a cross section of the steering wheel skeleton S.

The two variants of a steering wheel covering element according to FIGS. 11 and 12 are preferably joined to the steering wheel skeleton S by positive interlock or material fusion. It is naturally also possible to provide non-positive means of fixing. Such a steering wheel covering element is shown in FIG. 13 in association with FIGS. 14 and 15. Here a catch 15, which with a widened free end is capable of engaging and latching in a recess 16 in the steering wheel skeleton 1, is anchored in the steering wheel covering element 7, of semicircular cross-section and provided with the layer element 10a, on a flat inside 8 of the steering wheel covering element 7, which in the fixed state of the steering wheel covering element 7 faces the steering wheel rim skeleton 1. The steering wheel rim skeleton 1 of the steering wheel skeleton S is here of U-shaped cross section, and the recess 16 is formed on the steering wheel rim skeleton 1 of U-shaped cross section in such a way that a free leg 1a of the steering wheel rim skeleton 1 is situated opposite the recess 16 in an assembly direction M aligning with the recess 16, in which direction the catch 15 is inserted into the recess 16.

According to FIG. 15 it is also alternatively possible to provide a catch 15′, which has two widened free ends situated opposite one another, which each engage in a recess in the inside 8 and a recess in the steering wheel rim skeleton 1, so that a connection is made between the steering wheel covering element 7 and the steering wheel rim skeleton 1. Steering wheel covering elements of the type shown in FIG. 13 preferably serve for facing areas of the steering wheel rim skeleton 1 which face the hub 2 of the steering wheel and in which the struts 3a to 3d open out into the steering wheel rim skeleton 1.

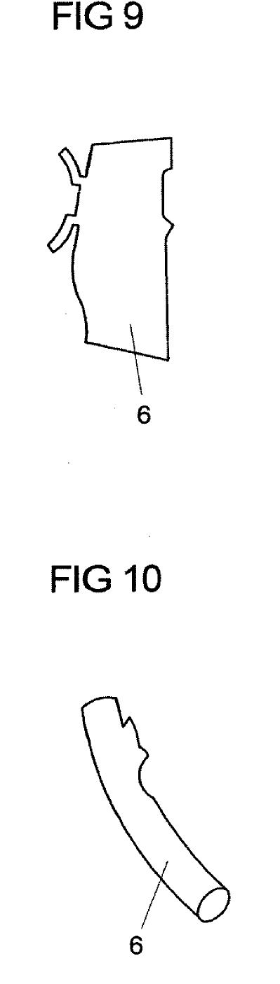

FIG. 5 in association with FIGS. 6 to 10 shows a schematic sequence of the individual steps of a method for producing a steering wheel of a motor vehicle. According to FIG. 5 the individual steering wheel covering elements 5c, 5d, 5e and 4b are first provided, which correspond to the steering wheel covering elements represented in FIG. 2, the difference compared to FIG. 2 being that the fourth steering wheel covering element 5b (and the second steering wheel covering element 5a, not shown) intended for the third and fourth struts 3b, 3d is divided into three parts 5c, 5d and 5e, of which a first part 5c is intended for covering the third strut 3b, a second part 5d for covering the fourth strut 3d of the steering wheel skeleton S and a third part for covering an area of the steering wheel skeleton 1 facing the hub 2, where the third and the fourth struts 3b, 3d merge into the steering wheel rim skeleton 1. Before the third steering wheel covering element 4b (which is mirror symmetrical with the first steering wheel covering element 4a) and the three-part fourth steering wheel covering element 5c, 5d, 5e are arranged on the areas of the steering wheel skeleton S intended for these, according to FIGS. 7 and 8, the outsides of the steering wheel covering elements 4b, 5c, 5d, 5e are each joined to a leather layer element 10a, in such a way that the outsides 9 are covered by the layer elements 10a. Before joining the layer elements 10a to the outsides 9 of the steering wheel covering elements 4b, 5c, 5d, 5e, these may each be preformed, as FIGS. 9 and 10 demonstrate from the example of a layer element 6, so that a layer element 10a intended for the respective steering wheel covering element 4b, 5c, 5d, 5e in each case has an inside 11, which is intended for fixing to one of the outsides 9 of the steering wheel covering elements 4b, 5c, 5d, 5e and which is matched to the three-dimensional shape of the respective outside. The performing serves to reduce any capacity of the layer elements (generally leather) for recovery, which makes facing of the steering wheel covering elements 4b, 5c, 5d, 5e very much easier.

Once the first and the three-part second steering wheel covering element 4a, 5a (neither of which is shown) and the third steering wheel covering element 4b and the fourth steering wheel covering element 5b, comprising the parts 5c, 5d, 5e have been joined to the associated layer elements 10a, preferably by adhesive bonding, the aforementioned steering wheel covering elements are arranged on and fixed to the predefined areas of the steering wheel skeleton S. Gaps formed between adjacent layer elements 10a or between adjacent free ends of the legs of the steering wheel covering elements, such as the gap T represented in FIG. 12, for example, which is formed between the free ends 7c, 7d of the two legs 7a, 7b of the first steering wheel covering element 4a, can then be sealed and decoratively trimmed by means of inserts 14 of the type shown in FIG. 12.

FIG. 16 in association with FIGS. 17 and 18 shows a modification of the steering wheel or steering wheel skeleton S shown in FIG. 12.

In this case the steering wheel skeleton S in FIG. 16 has a two-part construction, that is to say a core K as framework and a casing V partially enclosing the core K. The core K is preferably composed of a metal and comprises the hub 2 and elements proceeding therefrom as framework for three struts 3a, 3b and 3c of the steering wheel skeleton, which join the hub 2 to a further part of the core K, which provides a framework for the steering wheel rim skeleton 1.

The casing V, which is preferably molded onto the core K, is applied to the core K of the steering wheel skeleton S (also referred to as a preform). The casing V completely surrounds the core K, that is to say it encloses this, especially in the area of the steering wheel rim skeleton 1.

The casing V serves as carrier for the steering wheel covering elements 4a, which in cross section preferably enclose this tightly and in one piece and are thereby also fixed to the casing V. At the same time adjacent or opposing end faces of a steering wheel covering element 4a running completely (in one piece) around the steering wheel rim skeleton 1 are joined together by a seam N, which provides an extensive connection between those end faces 40 including the outer layer 10, which likewise runs round in one piece and is applied, in particular congruently, to the steering wheel covering element 4a.

In order to effectively prevent any twisting of those steering wheel covering elements 4a relative to the steering wheel rim skeleton 1 or the casing V transversely to the circumferential direction U, especially in the case of steering wheel covering elements 4a enclosing the steering wheel rim skeleton 1 in one piece, the steering wheel rim skeleton 1 (that is to say the casing V) has an external cross sectional contour in the form of a rounded rectangle. The core K by contrast has a U-shaped cross section in the steering wheel rim area, so that the casing V can be molded onto the core K to afford mechanical stability.

To improve the frictional grip between the steering wheel covering elements 4a to be fixed to the casing V and the casing V, an outward facing outside 20 (surface) of the casing V has graining with a high coefficient of friction. Such a friction-enhancing surface may also be provided by a comparatively finer surface texture (roughness) of the outside 20.

The improved frictional grip means that the steering wheel covering elements 4a faced with an outer layer 10 (for example leather, wood, etc) can be anchored to the steering wheel skeleton S in such a way that climatically induced variations in the length of the faced steering wheel covering elements 4a along the steering wheel skeleton S are reduced.

In addition, projections A in the form of annular beads, which are spaced in a circumferential direction U on the steering wheel rim skeleton 1, are integrally formed on the casing V in the circumferential direction U of the steering wheel rim skeleton 1. In this case each annular projection A runs entirely 360° around the steering wheel rim skeleton 1 of rectangular cross section, that is to say it forms a closed ring.

At least two projections A, which engage in recesses 30 on the inside 8 of the respective steering wheel covering element 4a, which are provided on edge sections of the respective steering wheel covering element 4a running opposite one another around the steering wheel rim skeleton in the circumferential direction U, are assigned to each steering wheel covering element 4a. Here these recesses 30 take the form of grooves facing the outside 20, which run annularly around the steering wheel rim skeleton 1, corresponding to the respectively assigned projection A.

Those projections A at points where two steering wheel covering elements 4a adjoin one another in the circumferential direction are therefore arranged in pairs adjacent to one another.

The projections A of the casing V engaging in at least two grooves 30 prevent any variation in the length of the respective steering wheel covering element 4a due to temperature fluctuations. Such variations in length may occur, in particular, due to facing of the steering wheel covering elements 4a with an external (visible) layer 10 of natural materials having a relatively high coefficient of expansion.

1. A method for producing a steering wheel, comprising the following steps:
provision of a steering wheel skeleton (S) as a body of the steering wheel to be produced,
provision of one or more steering wheel covering elements (4a, 4b, 5a, 5b) to be fixed to the steering wheel skeleton (S) as carriers for an outer, visible layer (10) of the steering wheel, all of the steering wheel covering elements (4a, 4b, 5a, 5b) together in the fixed state in essence completely enclosing at least a partial area of the steering wheel skeleton (S) and the steering wheel covering elements (4a, 4b, 5a, 5b) each having an inside (8) facing the steering wheel skeleton (S) and an outside (9) remote from the inside (8),
joining an outer layer (10) to the outside (9) of the at least one steering wheel covering element (4a, 4b, 5a, 5b), the outer layer (10) in the fixed state of the at least one steering wheel covering element (4a, 4b, 5a, 5b) in essence completely enclosing at least a partial area of the steering wheel skeleton (S), and
arrangement and fixing of the at least one steering wheel covering element (4a, 4b, 5a, 5b) on the steering wheel skeleton (S) once the outer layer (10) has been joined to the outside (9) of the at least one steering wheel covering element (4a, 4b, 5a, 5b).

2. The method as claimed in claim 1, characterized in that the outer layer (10) is formed in such a way that after joining to the outside (9) it covers the outside (9) of the at least one steering wheel covering element (4a, 4b, 5a, 5b).

3. The method as claimed in either of claims 1 or 2, characterized in that one or more of the steering wheel covering elements (4a, 4b, 5a, 5b) is/are fixed to the steering wheel skeleton (S) in such a way that all of the steering wheel covering elements (4a, 4b, 5a, 5b) together in essence completely enclose the steering wheel skeleton (S).

4. The method as claimed in one of claims 1 to 3, characterized in that the outer layer (10) is formed from a flexible material, in particular from a leather.

5. The method as claimed in one of the preceding claims, characterized in that the outer layer (10) has an inside (11), which is intended for joining to the outside (9) of the at least one steering wheel covering element (4a, 4b, 5a, 5b) and that the inside (11) is preformed in such a way that in essence it conforms to a three dimensional profile of the outside (9) of the at least one steering wheel covering element (4a, 4b, 5a, 5b).

6. The method as claimed in one of the preceding claims, characterized in that the outer layer (10) is joined to the outside (9) of the at least one steering wheel covering element (4a, 4b, 5a, 5b) by a materially fused connection.

7. The method as claimed in one of the preceding claims, characterized in that the at least one steering wheel covering element (4a, 4b, 5a, 5b) is joined by its inside (8) positively interlocking with the steering wheel skeleton (S).

8. The method as claimed in one of the preceding claims, characterized in that the at least one steering wheel covering element (4a, 4b, 5a, 5b) is joined by its inside (8) materially fusing with the steering wheel skeleton (S).

9. The method as claimed in one of claims 1 to 7, characterized in that the at least one steering wheel covering element (4a, 4b, 5a, 5b) is joined by its inside (8) forming a frictional connection with the steering wheel skeleton (S).

10. The method as claimed in one of the preceding claims, characterized in that multiple steering wheel covering elements (4a, 4b, 5a, 5b) are provided.

11. The method as claimed in claim 10, characterized in that the individual steering wheel covering elements (4a, 4b, 5a, 5b) are assigned to different areas of the steering wheel skeleton (S).

12. The method as claimed in one of the preceding claims, characterized in that the outer layer (10) is formed from multiple layer elements (10a).

13. The method as claimed in claim 10 or 11 and claim 12, characterized in that at least one of the layer elements (10a) is assigned to each of the individual steering wheel covering elements (4a, 4b, 5a, 5b).

14. The method as claimed in claim 12 or 13, characterized in that the layer elements (10a) are designed in such a way that after joining the layer elements (10a) to the outsides (9) of the steering wheel covering elements (4a, 4b, 5a, 5b) they cover the outsides (9) of the steering wheel covering elements (4a, 4b, 5a, 5b).

15. The method as claimed in claim 10 or 11 and one of claims 12 to 14, characterized in that after fixing two steering wheel covering elements (4a, 4b, 5a, 5b) to the steering wheel skeleton (S), an insert (14) is arranged in a gap (T), which is formed by opposing sides of two layer elements (10a) each fixed to the two steering wheel covering elements (4a, 4b, 5a, 5b).

16. The method as claimed in one of the preceding claims, characterized in that after fixing a steering wheel covering element (4a, 4b, 5a, 5b) to the steering wheel skeleton (S), an insert (14) is arranged in a gap (T), which is formed by opposing sides of the outer layer (10) fixed to the steering wheel covering element (4a, 4b, 5a, 5b).

17. The method as claimed in claim 15 or 16, characterized in that the insert (14) is designed to interlock positively with the gap (T).

18. The method as claimed in one of the preceding claims, characterized in that the cross sectional contour of the steering wheel skeleton (S) is formed in such a way that it deviates from a circular cross sectional contour.

19. The method as claimed in claim 18, characterized in that the cross sectional contour is of polygonal, especially rectangular shape.

20. The method as claimed in one of the preceding claims, characterized in that the step of providing a steering wheel skeleton (S) comprises the following steps:
provision of a core (K) for the steering wheel skeleton (S), especially one made up of metal, and
enclosure of the core (K) in a casing (V), especially one made up of a foam, in order to form the steering wheel skeleton (S), so that the casing (V), at least in sections, completely encloses the cross section of the core (K).

21. The method as claimed in one of the preceding claims, characterized in that projections (A) protruding from the steering wheel skeleton (S) are provided on the steering wheel skeleton (S), which are designed and intended to engage in corresponding recesses in an inside (8) of the at least one steering wheel covering element (4a, 4b, 5a, 5b).

22. The method as claimed in claim 21, characterized in that the projections (A) are formed on that part (1) of the steering wheel skeleton (S) which forms a body of the steering wheel rim of the steering wheel.

23. The method as claimed in claim 20 and either of claims 21 or 22, characterized in that the projections (A) are integrally formed with the casing (V).

24. The method as claimed in one of the preceding claims, characterized in that an outward facing outside (20) of the steering wheel skeleton (S) is endowed with a rough and/or grained surface texture.

25. The method as claimed in one of claims 7 to 9 or claim 21 or one of claims 22 to 24, in so far as these refer to claim 21, characterized in that the inside (8) is endowed with a rough and/or grained surface texture.

26. A steering wheel for a motor vehicle, comprising:
a steering wheel skeleton as a body of the steering wheel,
one or more steering wheel covering elements fixed to the steering wheel skeleton as carriers for an outer, visible layer of the steering wheel, all of the elements together in essence completely enclosing at least a partial area of the steering wheel skeleton and the elements each having an inside facing the steering wheel skeleton and an outside remote from the inside, and
an outer layer, which is joined to the outside of the at least one steering wheel covering element, the outer layer in essence completely enclosing at least a partial area of the steering wheel skeleton,
characterized in that
the at least one steering wheel covering element (4a, 4b, 5a, 5b) is designed and intended to be arranged and fixed on the steering wheel skeleton (S) once the outer layer (10) has been joined to the outside (9) of the at least one steering wheel covering element (4a, 4b, 5a, 5b).

27. The steering wheel as claimed in claim 26, characterized in that the outer layer (10) covers the outside (9) of the at least one steering wheel covering element (4a, 4b, 5a, 5b).

28. The steering wheel as claimed in either of claims 26 or 27, characterized in that all of the steering wheel covering elements (4a, 4b, 5a, 5b) together in essence completely enclose the steering wheel skeleton (S).

29. The steering wheel as claimed in one of claims 26 to 28, characterized in that the outer layer (10) is made up of a flexible material, in particular a leather.

30. The steering wheel as claimed in one of claims 26 to 29, characterized in that the outer layer (10) is joined to the outside (9) of the at least one steering wheel covering element (4a, 4b, 5a, 5b) by a materially fused connection.

31. The steering wheel as claimed in one of claims 26 to 30, characterized in that the inside (8) of the at least one steering wheel covering element (4a, 4b, 5a, 5b) bears on the steering wheel skeleton (S) positively interlocking therewith.

32. The steering wheel as claimed in one of claims 26 to 31, characterized in that the at least one steering wheel covering element (4a, 4b, 5a, 5b) has two opposing legs (7a, 7b) integrally joined to one another, which can be bent apart to enclose the steering wheel skeleton (S).

33. The steering wheel as claimed in claim 32, characterized in that the two legs (7a, 7b) each have a free end (7c, 7d), which bear against one another so that the at least one steering wheel covering element (4a) encloses the steering wheel skeleton (S).

34. The steering wheel as claimed in one of claims 26 to 33, characterized by multiple steering wheel covering elements (4a, 4b, 5a, 5b).

35. The steering wheel as claimed in claim 34, characterized in that a first steering wheel covering element (4a) extends over half of the circumference of a closed steering wheel rim skeleton (1) of the steering wheel skeleton (S).

36. The steering wheel as claimed claim 35, characterized in that the first steering wheel covering element (4a) in essence fully encloses the steering wheel rim skeleton (1), at least in sections.

37. The steering wheel as claimed in one of claims 34 to 36, characterized in that a second steering wheel covering element (5a) is provided, which extends along at least a first strut (3a) of the steering wheel skeleton (S) that serves to join the steering wheel rim skeleton (1) to a hub (2) of the steering wheel.

38. The steering wheel as claimed in claim 37, characterized in that the second steering wheel covering element (5a) in essence encloses the first strut (3a), at least in sections.

39. The steering wheel as claimed in claim 37 or 38, characterized in that the second steering wheel covering element (5a) extends along the first strut (3a) and along a further, second strut (3c), which serves to join the steering wheel rim skeleton (1) to the hub (2) of the steering wheel, and that the second steering wheel covering element (5a) covers an area of the steering wheel rim skeleton (1) between the two struts (3a, 3c) along the steering wheel rim skeleton (1).

40. The steering wheel as claimed in one of claims 37 to 39, characterized in that the second steering wheel covering element (5a) is designed in such a way that in its fixed state it in essence encloses the second strut (3c), at least in sections.

41. The steering wheel as claimed in one of claims 34 to 40, characterized in that a third steering wheel covering element (4b) is provided, which is mirror symmetrical with the first steering wheel covering element (4a) and is fixed to the steering wheel skeleton (S).

42. The steering wheel as claimed in one of claims 37 to 41, characterized in that a fourth steering wheel covering element (5b) is provided, which is mirror symmetrical with the second steering wheel covering element (5a) and is fixed to the steering wheel skeleton (S).

43. The steering wheel as claimed in one of claims 34 to 42, characterized in that one of the steering wheel covering elements (7) is fixed to the steering wheel skeleton (S) by means of at least one catch (15) fixed to its inside (8).

44. The steering wheel as claimed in claim 43, characterized in that the catch (15) engages in a recess (16) in the steering wheel skeleton (S) in order to join the one steering wheel covering element (7) to the steering wheel skeleton (S).

45. The steering wheel as claimed in one of claims 36 to 44, characterized in that the steering wheel skeleton (S) is of U-shaped cross section.

46. The steering wheel as claimed in claims 44 and 45, characterized in that the recess (16) is formed on the steering wheel skeleton (S) of U-shaped cross section in such a way that a free leg (1a) of the U-shaped steering wheel skeleton (S) is situated opposite the recess (16) in an assembly direction (M) aligning with the recess (16).

47. The steering wheel as claimed in one of claims 26 to 46, characterized in that the outer layer (10) comprises a plurality of layer elements (10a).

48. The steering wheel as claimed in claim 47, characterized in that at least one layer element (10a) is in each case joined to the outside (9) of a steering wheel covering element (4a, 4b 5a, 5b, 7).

49. The steering wheel as claimed in claims 47 and 48, characterized in that at least one layer element (10a) is in each case joined to the outside (9) of a steering wheel covering element (4a, 4b 5a, 5b, 7) in such a way that the outside (9) of the steering wheel covering element is in essence completely covered.

50. The steering wheel as claimed in one of claims 26 to 49, characterized in that at least one insert (14) is provided, which is arranged in a gap (T) in the outer layer (10).

51. The steering wheel as claimed in one of claims 47 to 49 and claim 50, characterized in that the gap (T) is arranged between adjacent areas of one or more layer elements (10a).

52. The steering wheel as claimed in one of claims 26 to 51, characterized in that the steering wheel covering elements (4a, 4b, 5a, 5b, 7) are made up of a plastic, in particular a thermoplastic.

53. The steering wheel as claimed in one of claims 26 to 51, characterized in that the steering wheel covering elements (4a, 4b, 5a, 5b, 7) are made up of a foam, in particular a PU foam.

54. The steering wheel as claimed in one of claims 26 to 53, characterized in that the steering wheel skeleton (S) has a cross sectional contour which deviates from a circular cross sectional contour.

55. The steering wheel as claimed in claim 54, characterized in that the cross sectional contour is of polygonal, in particular rectangular, shape.

56. The steering wheel as claimed in one of claims 26 to 55, characterized in that the steering wheel skeleton has a core (K), especially one made up of a metal.

57. The steering wheel as claimed in one of claims 26 to 56, characterized in that the steering wheel skeleton (S) has a casing (V), especially one made up of a foam.

58. The steering wheel as claimed in claim 56 and claim 57, characterized in that the casing (V) in essence completely encloses the core (K), at least in sections.

59. The steering wheel as claimed in one of claims 26 to 58, characterized in that the steering wheel skeleton (S) has projections (A) protruding from the steering wheel skeleton (S), which are designed and intended to engage in corresponding recesses (30) on the inside (8) of the at least one steering wheel covering element (4a, 4b, 5a, 5b).

60. The steering wheel as claimed in one of claims 57 or 58 and claim 59, characterized in that the projections (A) are integrally formed with the casing (V).

61. The steering wheel as claimed in either of claims 59 or 60, characterized in that the projections (A) are designed and intended to engage non-positively and/or by positive interlock in the associated recesses (30).

62. The steering wheel as claimed in one of claims 59 to 61, characterized in that the projections (A) are provided on that part (1) of the steering wheel skeleton (S) which forms a body for the steering wheel rim of the steering wheel.

63. The steering wheel as claimed in claim 62, characterized in that the projections (A) run around the cross section of the one part (1) of the steering wheel skeleton (S).

64. The steering wheel as claimed in one of claims 26 to 63, characterized in that an outward facing outside (20) of the steering wheel skeleton (S) has a rough and/or grained surface texture.

65. The steering wheel as claimed in one of claims 26 to 64, characterized in that the inside (8) has a rough and/or grained surface texture.

66. The steering wheel as claimed in one of claims 26 to 65, characterized in that the at least one steering wheel covering element (4a) completely encloses the cross section of the steering wheel skeleton (S), in particular the steering wheel rim skeleton (1), in one piece.
